(19) United States
(12) Patent Application Publication
(10) Pub. No.: US 2004/0073551 A1
(43) Pub. Date: Apr. 15, 2004

(54) Identification of multi-dimensional causal factors of variant phenomena

(76) Inventors: Ernest T. Hubbard JR., Mill Valley, CA (US); E. Allen Gleazer, San Francisco, CA (US); Nina Carino-Suchikul, South San Francisco, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/421,381

(22) Filed: Apr. 21, 2003

Related U.S. Application Data
(60) Provisional application No. 60/373,910, filed on Apr. 19, 2002.

(51) Int. Cl. G06F 7/00

(52) U.S. Cl. 707/6

(57) ABSTRACT

Events that occur over time or that otherwise have a time component are analyzed to identify one or more sets of causal factors that influence the aging distribution of the event. Data records that record the events are associated with patterns, where each pattern is associated with a group of data records that have one or more causal factors in common. The pattern having a metric indicative of an aging distribution influenced by the causal factors. In this way, the causal factors associated with the selected pattern are identified as having an influence on the aging distribution of the event. The method may be repeated to identify additional combinations of causal factors. In one example, the invention is applied to the problem of determining causal factors of problematic AR.

### CROSS REFERENCE TO RELATED APPLICATION

This application claims the benefit of U.S. Provisional Application No. 60/373,910, filed Apr. 19, 2002, which is hereby incorporated in its entirety by reference.

### BACKGROUND

1. Field of the Invention

This invention relates to the identification of multi-dimensional causal factors of variant phenomena, and in particular to identifying the causal factors that influence an aging distribution of an event.

2. Background of the Invention

The number of causal dimensions that influence a significant phenomenological event can be dramatically large. For example, the factors that can cause disease, influence the price of a stock, or determine the outcome of a horse race are complex and sometimes hidden. The sheer multi-dimensionality and volume of these causal factors can make the task of identifying them overwhelming for the human mind. For example, a single event, involving millions or billions of “outcomes,” can be influenced by 5, 6, 15, or more dimensions of causality, many of which are in a state of dynamic flux. Clearly, the ability of the human mind to identify and predict underlying causal factors in such complex systems is severely limited. This is especially true in the context of the modern information age, where enormous amounts of data containing inter-related and ever-changing information can be collected for many events that require rapid decision-making and reporting. The consequences of this limitation are far-reaching and impact many important aspects of modern life. In particular, the financial and business sectors of modern economies are limited in their efficiency and decision-making processes.

An example of such a complex system is the United States healthcare system. The economic value of this system can be measured in one way by the total value of the accounts receivables (AR). In 2001, this total AR was valued at approximately $1.3 trillion and is projected to grow to $2.6 trillion by 2006. Few financial transaction systems are as large or complex as the United States healthcare industry. Billions of medical procedures are performed annually on hundreds of millions of patients, by hundreds of thousands of physicians at tens of thousands of medical facilities, all of which are billed to tens of thousands of “obligors” (patients, insurance plans, governmental agencies, etc.). Therefore, this industry as a whole, and segments of it, is an excellent example of a complex system in which many causal factors influence the outcome of events, such as the payment of AR.

In a healthcare facility, an AR manager is tasked with the job of monitoring AR performance and determining why unpaid claims have not been “adjudicated” (i.e., paid or written-off). This is a formidable task even for the most industrious and intelligent of managers. In point of fact, it is estimated that of the $1.3 trillion in outstanding receivables in the United States healthcare industry, approximately 50% of outstanding receivables are “at risk” of being paid slowly, at a lower than expected rate, or not at all. Of this $625 billion of “at risk” AR, it is estimated that about 50% will never be paid at all, ultimately written off as bad debt.

The size and complexity of the healthcare reimbursement system make it almost impossible to determine causes for nonpayment using traditional software tools and/or human analysis. A typical medical center will have hundreds or thousands of physicians, procedures, and payors. Typically, to track unpaid claims, a healthcare billing operation will produce standard aging reports which are distributed to AR staff for follow up. There is very little meaningful analysis in these reports of the causes of unpaid claims, as the reports merely summarize amounts. They provide little assistance to AR staff in their collection efforts, especially as it relates to identifying cause-and-effect patterns responsible for non-payment. In addition, resolution of unpaid AR is usually given a lower priority than posting charges and payments. Consequently, unpaid AR tends to remain unresolved until either it is beyond statute for payment, or until it has become so complex in its history that it must be either written-off or sent to an outsource firm for collection at a very high fee.

In the absence of an accurate, efficient and user-friendly technology to identify the underlying causes of complex phenomena, workers in the subject matter have dealt with it in one or more of the following ways:

(1) Utilize then-current analytic, statistical and computer-based approaches to generate reports;

(2) Add more people to the decision-making and resolution task; or

(3) Deal with the largest, most obvious and simplistic problems, and leave the more complex problems to “sort themselves out.”

Regarding (1), above, current analytic, statistical and computer-based approaches are severely limited in their ability to answer effectively complex causal questions. They tend to be one-dimensional in nature and often require human intervention and “guidance”; hence, they lack objectivity.

The problems with such an approach are numerous and significant. First, the reliance on human intuition in the problem-solving process creates some level of subjectivity affecting the outcome. Secondly, the process is laborious, time-consuming, and requires a relatively high level of skill in the use of computers, the manipulation of data files, and an expert understanding of the underlying cause-effect relationships of the problem being studied. Thirdly, the reports typically generated by such an approach are not highly actionable, in that they require secondary interpretation and analysis before they can be used as a true decision support and problem-solving tool. Fourthly, the very process of “slicing” or “drilling” (i.e., looking at a section of the data having one or more factors in common) can interfere with the phenomenon that this at the core of the investigator's search.

Regarding (2), above, the addition of people to the task has not proven an effective solution because the level of skill required to address such complex problems is significant. Moreover, the cost of hiring such skilled staff renders this solution financially prohibitive in many cases.

Solution (3), above, is perhaps the most often selected, in which people migrate to those problems that they can see and they have some chance of solving. All other problems, those with less visible symptoms and more complex causal factors, tend to remain unsolved until they are either rectified by sheer coincidence or are eventually written off (in the case of healthcare, as “bad debt”). Often, problems occur when a large number of small claims have a common cause. Such problems are not addressed when managers ignore these to focus instead on “high dollar” claims.

Accordingly, there is a need for a system and method for identifying multi-dimensional causal factors in variant phenomena while overcoming the problem of the prior art.

### SUMMARY OF THE INVENTION

The invention is directed to identifying the causal factors that influence an aging distribution of an event, which can be achieved for example using a method, a system, or a computer program product. In a general sense, the invention is applied to analyze events that occur over time or that otherwise have a time component. Each instance of an event occurs under certain conditions, which include a number of causal factors that are theorized to possibly influence the aging of the event in a particular manner. This invention helps to identify the particular causal factors, or the particular combinations of causal factors, that influence the occurrence of those events over time.

In one embodiment of the invention, a method is used to identify the causal factors that influence an aging distribution of an event. The method uses a plurality of data records that have an aging distribution, where each data record specifies an amount, an age of the amount, and the causal factors associated with the data record. A number of patterns are defined such that each pattern is associated with a group of data records that have one or more causal factors in common. A pattern can be one or multi dimensional in its causal factors. Once the patterns are defined, a metric is computed for each pattern. The metric, based on an aging distribution of the data records associated with the pattern, can be defined in any among a variety of suitable ways for describing the pattern. The pattern having a metric most indicative of a predefined aging distribution is then selected. In this way, the set of one or more causal factors associated with the selected pattern are identified as having an influence on the aging distribution of the event.

In an embodiment, the method further comprises removing the data records associated with the selected pattern and then repeating the method to select a next pattern having causal factors most indicative of influencing the aging distribution of the event. In this way, several sets of causal factors can be identified as having an impact on the aging distribution of the event. However, removing the data records associated with the patterns previously identified helps to avoid skewing the identification of additional patterns. In other embodiments, the method includes generating reports, listing the identified patterns according to, for example, the total of the amounts of the data records associated with the patterns, the patterns' metric from the target aging distribution, or at least one of the causal factors.

In another embodiment, the invention is used to identify causal factors that cause problematic accounts receivables (AR). The AR is represented by a plurality of billing records, where each billing record specifies an amount billed, an age or date of the bill, and the causal factors associated with the bill. In this embodiment, a plurality of patterns are defined such that each pattern is associated with a group of bills that have one or more causal factors in common. A metric that reflects an aging distribution of the bills associated with the pattern is computed. A pattern having the highest aging distribution according to its computed metric is selected, whereby the set of causal factors associated with the selected pattern has an influence on the quality of the accounts receivables. In one embodiment, the bills associated with the selected pattern are removed from consideration and the process is repeated, thereby identifying additional patterns that have an influence on the quality of the accounts receivables. Therefore, applying the invention to the problem of AR aging allows the factors that cause a late aging distribution of unpaid bills to be determined. Knowing what factors are causing problematic AR enables a business owner to direct attention to those particular problems.

### BRIEF DESCRIPTION OF THE DRAWINGS

FIG. 1 is a flowchart of an embodiment of a method for identifying causal factors that influence an aging distribution of an event.

FIG. 2A is a sample graph of a target aging distribution according to an embodiment.

FIGS. 2B and C are sample graphs of the aging distribution of the data records of two example patterns.

### DETAILED DESCRIPTION OF THE PREFERRED EMBODIMENTS

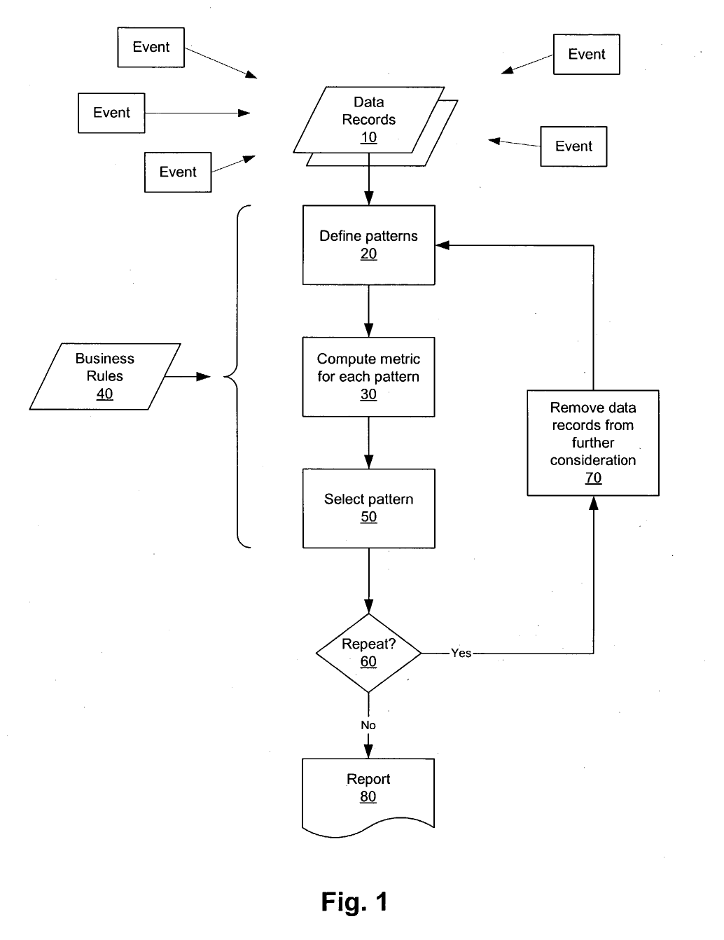

This invention relates to the identification of multi-dimensional causal factors of variant phenomena, and in particular to identifying the causal factors that influence an aging distribution of an event that occurs over time. FIG. 1 is a flowchart of a method for identifying causal factors that influence an aging distribution of an event. The event is measured by a set of data records 10, where a data record 10 reflects an instance or occurrence of the event. Each data record 10 includes an amount, an age associated with that amount, and a set of causal factors associated with the data record 10. The data record 10 may include the age associated with the amount by indicating a date for the event, whereby the age can be readily calculated. The causal factors for a data record describe the particular conditions that existed when the event associated with the data record 10 occurred. Preferably, the causal factors used include those factors that are suspected to have an effect on the aging of the event.

The invention can better be appreciated in the context of an example, although the invention can be applied to any of a variety of problems in which the causal factors that have a specified effect on the aging distribution of an event are sought. In one embodiment, the invention is used to identify causal factors that cause problematic accounts receivable (AR). AR is termed problematic when it remains unpaid for a time longer than that deemed appropriate. In the case of identifying problematic AR, the data record is a billing record of a billing event, specifying the amount billed, the age of the bill, and the causal factors associated with the bill. Again, the age of the bill may be specified with a date for the bill, whereby the bill's age is calculated.

The causal factors associated with a billing event include attributes that describe the circumstances of the event that resulted in the bill. For example, in the field of healthcare receivables, it has been found that the following three types of causal factors (or dimensions of causal factors) are useful in determining the cause of AR aging: payor (e.g., a particular insurance company), provider (e.g., a particular doctor), and procedure (e.g., a particular procedure or service provided). A billing record typically specifies the causal factors associated with the billing event, such as the payor entity being billed, the procedure or service for which the bill is being charged, and the doctor that performed the procedure.

In the case of healthcare services, it will often be the case that several causal factors would be associated with a billing event. Continuing this example, two doctors might perform an operation, a single doctor might perform multiple procedures on a patient, or a patient might have both primary and secondary insurance companies as payors of the bill. In each of these cases, there are more than one combinations of causal factors associated with the billing event. In one embodiment, the bill—including the entire billed amount and its age—is associated with each causal factor, e.g., both doctors, all procedures, or both payor insurance companies. However, to the extent that the amount billed can be separated and portions of it can be allocated among the various causal factors, it may be desirable to do so. In the example where a doctor performs two procedures, the different billed amounts could easily be allocated to their corresponding procedure. Effectively, this results in two separate billing records, each record associated with the same provider and payor, but having different procedures and different amounts billed corresponding to those procedures.

It can be appreciated, however, that persons skilled in the art can define different sets of causal factors based on the particular problem to be solved and their understanding of factors likely to have a significant effect on the aging of the event. The present invention allows for flexibility in the way the problem is set up, including the definition of the causal factors and how records are created from the events.

Given the set of data records 10, a number of patterns are defined 20. A pattern is defined as a collection of a group of data records that have one or more causal factors in common. Each type of causal factor may be thought of as a dimension; hence, the patterns may be one or multi-dimensional. For example, in the AR case, one pattern might be all records having a procedure of X. In this case, the pattern is one-dimensional, that dimension being the procedure associated with the bill. The actual causal factor associated with that pattern is a particular procedure, procedure X. This pattern is not limited as to the dimensions of provider or payor, so billing records of any provider or payor may be included within that pattern. In another example, a pattern might be defined as all records having a procedure of Y, a payor of A, and a provider of Z. This example pattern is three-dimensional in the sense that its data records are limited in all three dimensions of procedure, provider, and payor. Only those billing records that have all three of the specified causal factors are included in the pattern.

It is noted that a data record can be, and often is, associated with more than one pattern. For example, a billing record of a procedure X performed by Dr. Smith would be associated with the one-dimensional pattern that specifies procedure X, with the one-dimensional pattern that specifies provider Dr. Smith, and with the two-dimensional pattern that specifies procedure X and provider Dr. Smith. However, the billing record would not be associated with the two-dimensional pattern that specifies procedure X and provider Dr. Jones.

It can be appreciated that the dimensions and the possible causal factors in each dimension are specified by an administrator given the problem to be solved and the data available. For example, as applied to receivables collections in a law firm, the possible dimensions might include the client, the partner assigned to manage the client, the attorney who provided the services, the services provided, and any other attribute of the billing event that could affect collections of the bill over time. Accordingly, each record would specify an amount billed, an age of that bill (e.g., commonly by indicating the date of the bill), and each of the causal factors associated with the bill.

In one embodiment, a system determines every possible pattern—i.e., every combination of values for each combination of dimensions—for which there are data records 10. However, just as the causal factors can be selected to suit the problem to which the invention is applied, so can the selection of patterns. Where it would make no sense or be of little use to define 20 a particular pattern, that pattern may be excluded from step 20.

Once the patterns are defined 20, a metric is computed 30 for each pattern based on the aging distribution of the data records 10 associated with the pattern. The metric provides a measure of the aging of those records 10, thus allowing the patterns to be compared. The particular technique for computing the metric is selected based on the particular problem being solved. In one embodiment of an AR example, the metric is based on or defined as the weighted average age of the bills associated with the pattern. In one embodiment, the weighted average is computed according to:

$$metric = \frac{\sum ( {age}_{i} \cdot amount {billed}_{i} )}{\sum amount {billed}_{i}} .$$

In the context of AR, this weighted average provides a measure of the lateness of the AR as reported by the data records in the particular pattern. This formula is presented for illustration purposes, and other metrics may be used for different applications. For example, it may be desirable to weight the average age non-linearly, so that overdue bills of a higher amount are given even greater weight. Additionally, it may be desirable to ignore bills that are under a predetermined amount or under a predetermined age. In an embodiment, a set of business rules 40 are used to specify these settings. The business rules 40 may be selected by a user before the method is performed, allowing the user to customize the method for a given problem.

The next step is to select 50 the pattern in which the aging distribution of the data records is most indicative of being influenced in a particular manner. This selection 50 is performed using the metric computed for each pattern, wherein the pattern is selected 50 by evaluating the metric associated with each pattern to determine the degree to which that metric reflects a particular aging distribution. This depends on how the metric is computed and on the goal of what causal factors are sought. For example, if the goal is determine problematic (i.e., late) AR and the metric used is the weighted average age of the AR as described above, the pattern having the largest metric would be selected 50. This is because the largest metric corresponds to the latest unpaid AR, or most problematic AR, which is the particular influence for which causal factors are sought. Having selected 50 a pattern, it is determined that the causal factors associated with that pattern are those having the strongest influence on the event in that particular manner (e.g., causing late AR).

Continuing with the healthcare receivables example, consider the example that the pattern selected as having the highest metric (i.e., latest AR) is the one associated with provider X and procedure B. Accordingly, the result of the analysis is that the causal factors of provider X and procedure B, in that particular combination, influence collections of AR by causing them to be late. Additionally, the value of the selected pattern is not just in the causal factors that it identifies, but those not identified. In this example, the identified pattern does not specify any payor, indicating that the problem AR occurs regardless of which payor (i.e., that dimension does not contain an indicated causal factor). Accordingly, this potential problem having been diagnosed, an AR manager can investigate further into why the bills are not being paid when provider X performs procedure B, irrespective of the payor of the bill. For example, perhaps provider X's secretary systematically encodes the incorrect billing code for procedure B, causing the bills to go unpaid or be paid late because the error has to be tracked down and fixed. This analysis provides a useful diagnostic that instantly pinpoints a problem that might otherwise go unnoticed.

It can be appreciated that the particular manner in which a pattern is selected 50 will depend on the definition of the metric in step 30 and the overall goal of what is to be identified. For example, consider the case where the metric is the weighted age of AR and the goal is to identify the factors that cause late AR. In this example, the metric is defined in such a way that the pattern having the highest metric is selected 50, as this pattern is the one that has the most similar aging distribution to that for which the causal factors are to be identified. In one embodiment, this selection 50 of the pattern is performed by ranking the patterns according to their associated metrics, and choosing the pattern having the highest metric (or lowest, depending on how the metric is defined).

In another embodiment, step 50 is performed by reference to a target aging distribution. In one embodiment, the pattern having a metric most indicative of an aging distribution that deviates from the target's aging distribution is selected 50. In another embodiment, the target aging distribution defines an ideal distribution. In this case, the identified pattern is that which has a metric most similar to that of the target. In an example case for diagnosing problematic AR, the target aging distribution could represent what an AR administrator determined to be a minimally “healthy” AR, which could be described according to the desired or acceptable percentages of AR at various time periods (such as 30, 60, 90, 120 days). The target aging distribution is stored in one embodiment in the business rules 40, which can be defined by an administrator before performing the analysis.

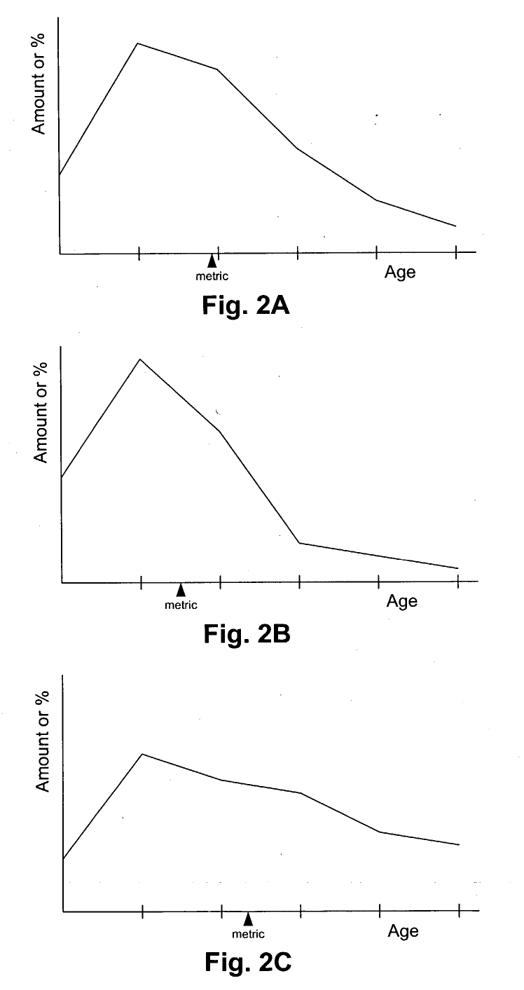

FIGS. 2A through C show graphical representations of a target distribution (FIG. 2A) and the aging distribution of the data records for two example patterns (FIGS. 2B and C). These graphical representation can be understood in the context of AR aging, where the dependent variable axis is defined as the amount of AR for a given age (or alternatively, it can be represented as a percentage of the total AR, which has the effect of normalizing the graphs for each set of data), and the independent variable axis is defined as the age. The user can define a target profile, shown in FIG. 2A, in the business rules 40 to define, e.g., the threshold between a “good” and a “bad” AR distribution. Furthermore, a metric is computed for the target profile for the purpose of comparing the target to actual patterns, i.e., to distinguish between “good” and “bad” patterns of data records. In this example, the metric is the weighted average age, and is shown graphically on the Age axis.

Continuing this example, FIGS. 2B and C show aging distributions for two different example patterns. In the AR context, FIG. 2B represents an aging distribution in which the AR is relatively young compared to the target profile. This is typically considered desirable. Likewise, FIG. 2C shows the aging distribution for the set of data records associated with a pattern. In this example, the AR is relatively old compared to the target profile. A metric, defined as the weighed average age, is computed for each pattern and is shown on their respective Age axes. It is observed that the metric for FIG. 2B is lower than the metric for the target profile, whereas the metric for FIG. 2C is higher. This indicates what can be seen graphically: that the pattern associated with FIG. 2B represents AR that is paid more quickly than the target, while the pattern associated with FIG. 2B represents AR that is paid more slowly than the target. In this way, the metrics are used to compare particular characteristics (such as the weighted average age) of each pattern's aging distribution, and thereby select particular patterns according to these characteristics. Thus, in the AR example, problematic AR can be determined so that the causal factors associated with the selected patterns can be identified.

In another embodiment, after a first pattern is selected 50 and its associated causal factors identified, the process is repeated 60 to identify additional patterns and their associated sets of causal factors. The process can be repeated 60 a predetermined number of times to obtain that number of patterns. Alternatively, the process is performed until a particular condition exists, for example until all patterns having a metric larger than a target metric are located. In another alternative, to obtain a full ranking of patterns, the process is repeated 60 for all of the possible patterns.

Preferably, each time the process is repeated 60, the data records 10 associated with the previously selected 50 pattern are removed 70 from further consideration. These removed records are not used in subsequent computations of a pattern's metric (in step 30), even if the removed record has the pattern's causal factors. This can happen when, for example, a pattern associated only with provider A was previously selected 40. Thus, it has already been determined that a potential problem exists with respect to that particular doctor, provider A. Accordingly, all data records associated with provider A are removed 70 from further consideration so that the determination of additional patterns will not be affected by whatever influence provider A had on AR aging. In this way, a diagnosed problem (as indicated by a set of causal factors determined to cause late AR) will not skew the ability of the system to diagnose additional problems. The algorithm can thus identify additional problematic patterns in the data that may have been obscured by the other problematic patterns.

After the one or more patterns are identified, their associated causal factors are reported 80 to a user. Various reporting techniques can be used to summarize the selected patterns. In an embodiment, the reports list the selected patterns by one or more of: the total of the amounts of the data records associated with the pattern; the pattern's metric; and at least one of the causal factors. For example, reporting the problematic AR patterns according to their dollar value allows an AR manager to approach those problems first where there is the greatest potential for improvement. On the other hand, reporting problematic AR patterns by their computed metrics gives the AR manager an indication of where the potentially largest problems exists. It can be appreciated that the reporting techniques can be tailored to suit the needs of the particular problem.

In the AR example, these reports provide a guided mechanism that a business can use to address and correct each problematic receivables pattern systematically. The reports identify key problem “patterns” of unpaid accounts and their associated causal factors (e.g., payors, providers, procedures). It is further envisioned that the results of an analysis in accordance with the invention can be reported using graphical techniques, such as three-dimensional surface graphs, three-dimensional contour graphs, and radar graphs. Benefits of such graphing techniques include allowing a user to visualize the data more easily, and hence more easily determine causal factors. These graphs also allow more easy identification of “spikes” in the data.

The present invention has been described in connection with solving the problem of determining causal factors for problematic AR; however, the applications of the invention are described by way of example only. In another embodiment, the method is used to identify causal factors for receivables that have a high write-off percentage. This process is similar to the AR example, except the metric used is the write-off percentage for the bills associated with each record. This allows for identification of the causal factors that lead to write-offs. Additionally, persons skilled in the art will understand that the method can be applied to a variety of problems to identify factors that affect the aging of events described. This robust technique can be applied to any set of data for which the factors (or dimensions of a set of data) that cause a particular result are sought. This result can be measured by any type of metric, for example the difference between a target and actual weighting of AR aging, as the metric is tailored to the particular application. As applied to identifying problem AR, the invention provides meaningful, action-based and results-oriented reports for use in effectively solving one's receivables problems. These tools, coupled with AR services and training, enable highly-efficient claims resolution and accelerated and increased reimbursements. In addition, identifying the causes for unpaid claims gives new insight into inefficiencies and problems within the operations of a business that, once corrected, will eliminate similar problems from recurring in the future.

An embodiment of the invention can be implemented in a computer system including a relational database that stores the various bills, accounts, and computed values in various database tables, and a workstation computer including software modules that implement the algorithm in various classes or components.

The foregoing description of the embodiments of the invention has been presented for the purposes of illustration and description. It is not intended to be exhaustive or to limit the invention to the precise forms disclosed. Persons skilled in the relevant art can appreciate that many modifications and variations are possible in light of the above teaching. It is therefore intended that the scope of the invention be limited not by this detailed description, but rather by the claims appended hereto.

We claim:

1. A computer-implemented method for identifying causal factors that influence an aging distribution of a plurality of data records, where each data record specifies an amount, an age of the amount, and a plurality of causal factors associated with the data record, the method comprising:
defining a plurality of patterns, each pattern having one or more causal factors;
associating each pattern with the data records having the causal factors that correspond to the pattern;
computing a metric for each pattern from the data records associated with the pattern, the metric based on the aging distribution of the data records associated with the pattern; and
identifying at least one pattern having a metric indicative of an aging distribution influenced by the causal factors.

2. The method of claim 1, wherein the metric is based on a weighted average age of the data records associated with the pattern.

3. The method of claim 1, wherein each data record represents a billing record in an accounts receivable, the amount associated with the data record is an amount billed, and the age of the amount is the age of the bill.

4. The method of claim 3, wherein the causal factors for each data record specify at least a payor, a provider, and a procedure associated with the billing record.

5. The method of claim 1, further comprising:
removing from further consideration the data records associated with the selected pattern;
recomputing the metrics for each pattern based on the aging distribution of the data records associated with the pattern that have not been removed from further consideration; and
identifying at least one additional pattern having a recomputed metric indicative of an aging distribution influenced by the causal factors.

6. The method of claim 1, further comprising:
generating a report that summarizes the selected patterns, the report listing each pattern according to the total of the amounts of the data records associated with the pattern.

7. The method of claim 1, further comprising:
generating a report that summarizes the selected patterns, the report listing each pattern according to its metric.

8. The method of claim 1, further comprising:
generating a report that summarizes the selected patterns, the report listing each pattern according to at least one of the causal factors.

9. The method of claim 1, wherein identifying at least one pattern comprises:
computing a metric for a target aging distribution;
disregarding the patterns having a metric within a range defined by the metric of the target aging distribution; and
identifying the pattern having a metric with the largest deviation from the target aging distribution's metric.

10. The method of claim 1, wherein a data record is associated with more than one pattern.

11. A computer program product for identifying causal factors that influence an aging distribution of a plurality of data records, where each data record specifies an amount, an age of the amount, and a plurality of causal factors associated with the data record, the computer program product comprising a computer-readable medium containing computer program code for performing the operations:
defining a plurality of patterns, each pattern having one or more causal factors;
associating each pattern with the data records having the causal factors that correspond to the pattern;
computing a metric for each pattern from the data records associated with the pattern, the metric based on the aging distribution of the data records associated with the pattern; and
identifying at least one pattern having a metric indicative of an aging distribution influenced by the causal factors.

12. The computer program product of claim 11, wherein the metric is based on a weighted average age of the data records associated with the pattern.

13. The computer program product of claim 11, wherein each data record represents a billing record in an accounts receivable, the amount associated with the data record is an amount billed, and the age of the amount is the age of the bill.

14. The computer program product of claim 13, wherein the causal factors for each data record specify at least a payor, a provider, and a procedure associated with the billing record.

15. The computer program product of claim 11, wherein the computer-readable medium further contains computer program code for performing the operations:
removing from further consideration the data records associated with the selected pattern;
recomputing the metrics for each pattern based on the aging distribution of the data records associated with the pattern that have not been removed from further consideration; and
identifying at least one additional pattern having a recomputed metric indicative of an aging distribution influenced by the causal factors.

16. The computer program product of claim 15, wherein the computer-readable medium further contains computer program code for performing the operations:
generating a report that summarizes the selected patterns, wherein the report lists the selected patterns by at least one of the following:
according to the total of the amounts of the data records associated with the pattern,
according to the pattern's metric, and
according to at least one of the causal factors.

17. The computer program product of claim 11, wherein identifying at least one pattern comprises:
computing a metric for a target aging distribution;
disregarding the patterns having a metric within a range defined by the metric of the target aging distribution; and
identifying the pattern having a metric closest to the target aging distribution's metric.

18. A computer-implemented method for identifying causal factors that cause problematic accounts receivables, the accounts receivables represented by a plurality of billing records each of which specifies an amount of a bill, an age of the bill, and the causal factors associated with the bill, the method comprising:
defining a plurality of patterns, each pattern having one or more causal factors;
associating each pattern with the data records having the causal factors that correspond to the pattern;
computing a metric for each pattern from the data records associated with the pattern, the metric based on the aging distribution of the data records associated with the pattern; and
identifying at least one pattern having a metric indicative of the most problematic aging distribution.

19. The method of claim 18, wherein the metric is a weighted average age of the amounts billed associated with the pattern.

20. The method of claim 18, wherein the causal factors for each billing record include at least a payor, a provider, and a procedure for the bill.

21. The method of claim 18, further comprising:
removing from further consideration the billing records associated with the selected pattern;
recomputing the metrics for each pattern based on the aging distribution of the billing records associated with the pattern that have not been removed from further consideration; and
identifying at least one additional pattern having a recomputed metric indicative of problematic accounts receivables.
